(19) United States
(12) Patent Application Publication
(10) Pub. No.: US 2024/0218486 A1
(43) Pub. Date: Jul. 4, 2024

(54) ALUMINUM ALLOY FOR ADDITIVE MANUFACTURING

(71) Applicant: EOS of North America, Inc., Novi, MI (US)

(72) Inventors: Ankit Saharan, Novi, MI (US); Zaynab Munther Mahbooba, Novi, MI (US)

(73) Assignee: EOS of North America, Inc., Novi, MI (US)

(21) Appl. No.: 18/092,671

(22) Filed: Jan. 3, 2023

(51) Int. Cl. C22C 21/06; B22F 10/28; B22F 10/64; B33Y 10/00; B33Y 70/00; C22C 1/04; C22C 21/00

(52) U.S. Cl. CPC C22C 21/06; B22F 10/28; B22F 10/64; B33Y 10/00; B33Y 70/00; C22C 1/0416; C22C 21/00; B22F 2301/052; B22F 2998/10

(57) ABSTRACT

Disclosed is an aluminum alloy that includes at most 4.50% by weight magnesium, about 0.10 to about 5.00% by weight manganese, about 1.00 to about 2.00% by weight zirconium and aluminum as the remainder. The aluminum alloy does not include any intentionally added zinc. Further disclosed is an aluminum alloy including at most 4.50% by weight magnesium, more than about 1.00% by weight manganese, about 1.00 to about 2.00% by weight zirconium and aluminum as the remainder. Further disclosed is a method of producing an aluminum alloy, a method for producing a component using the aluminum alloy, a use of the aluminum alloy in an additive manufacturing process, and a component including the aluminum alloy.

### TECHNICAL FIELD OF THE INVENTION

The invention relates to an aluminum alloy comprising magnesium, manganese, zirconium and aluminum and to a method for producing said aluminum alloy and to a method for producing a component using said aluminum alloy. The invention further relates to a component comprising said aluminum alloy and to a use of the aluminum alloy.

### BACKGROUND OF THE INVENTION

For producing prototypes and in series production, additive manufacturing processes become more and more relevant. In general, “additive manufacturing processes”, which are also termed “three-dimensional (3D) printing”, are those manufacturing processes in which a manufacturing product or component is usually built on the basis of digital 3D design data by depositing a build-up material of the component layer by layer.

For creating a component, material is selectively melted and resolidified, whereby this melting can typically be performed by irradiation with radiation energy, e.g. electromagnetic radiation, especially light and/or thermal radiation, but possibly also with particle radiation, e.g. electron radiation. A prominent example is Laser Powder Bed Fusion (LPBF), which is an additive manufacturing method that operates with irradiation, e.g. a laser beam. Here, thin layers of a usually powdered build-up material are applied one on top of the other repeatedly, wherein the build-up material in each layer is selectively melted by spatially limited irradiation of the points that, after manufacture, are intended to belong to the manufacturing product to be produced. The powder grains or particles of the build-up material can be partially or completely melted by the local introduction of energy by irradiation. After cooling, these selectively irradiated powder grains are then connected to one another in a solid body.

Different powders are known as build-up material, which can be adapted to the field of application of the finished component, e.g. different types of metal alloys. In some areas of application, components are required that are lightweight and have high strength in combination with high ductility and elevated temperature performance. In the context of this invention, materials that meet these requirements and are suitable for additive manufacturing are referred to as high-temperature precipitation strengthened metal alloys. This concerns for example applications like aerospace, defense, automotive or structural components.

Existing high-temperature precipitation strengthened aluminum (Al) alloys (abbreviated to HTPSA) used for additive manufacturing typically comprise magnesium (Mg) and can contain scandium addition or zirconium addition. Magnesium serves as a solid solution strengthener in these alloys while the addition of scandium (Sc) and/or zirconium (Zr) results in Al₃(Sc, Zr) precipitates that can provide additional strengthening.

A disadvantage of known Al—Mg—(Sc, Zr) alloys can be their magnesium content, which can have negative impact on the processability of the aluminum alloy, especially during additive manufacturing processes. Magnesium has one of the highest equilibrium vapor pressures among common solutes in aluminum alloys, so it is prone to vaporization during manufacturing of a powder feedstock for additive manufacturing and during the additive manufacturing process. There are assumptions that significant amounts of the magnesium used in aluminum alloys can be lost due to vaporization regarding additive manufacturing processes and is therefore no longer available for the buildup of the component.

In many cases, a loss of magnesium from the aluminum alloy may be detrimental to the mechanical properties of the manufactured components comprising the alloys. By way of example, an unintended evaporation of magnesium is likely to reduce strength of the component and/or can result in the formation of keyhole porosity. Additionally, oxidized magnesium vapor or “smoke” can land in the build area of an additive manufacturing machine and become incorporated into the unprocessed build-up material, further compromising component quality.

### SUMMARY OF THE INVENTION

It is an object of the present invention to provide an aluminum alloy, a method for producing an aluminum alloy, a method for producing a component using an aluminum alloy as well as a component comprising an aluminum alloy, by which at least some of the aforementioned disadvantages can be reduced.

An aluminum alloy according to the invention, in particular an aluminum alloy powder, comprises at most 4.50% by weight magnesium (Mg) and about 0.10% by weight to about 5.00% by weight manganese (Mn) and about 1.00% by weight to about 2.00% by weight zirconium (Zr) and aluminum (Al) as the remainder. The quantities mentioned here and in other parts of the description refer to the total quantity respectively the total weight of the provided aluminum alloy, unless otherwise stated. An alloy is understood, as in general, to be a macroscopically homogeneous metallic material consisting of at least two elements (components), at least one of which is a metal and which together exhibit the metal-typical characteristic of metal bonding.

The aluminum alloy is in particular suitable for additive manufacturing processes (as build-up material). The aluminum alloy is preferably suitable for heat treatment, especially after processing a powdered aluminum alloy in an additive manufacturing process. This is described in detail later.

The aluminum alloy preferably provides a high-temperature precipitation strengthened aluminum alloy (HTPSA), especially after heat treatment of the aluminum alloy. In particular, a high-temperature precipitation strengthened aluminum alloy can be obtained by means of heat-treating or heat aging of the aluminum alloy according to the invention.

According to the invention the aluminum alloy does not comprise any intentionally added zinc (Zn). This means that no zinc is added to the aluminum alloy on purpose during manufacture and/or processing of the aluminum alloy. However, the aluminum alloy might comprise metallic or metalloid impurities to a certain extent. Impurity in this context refers to a metallic or metalloid additive that does not affect the other intended strengthening mechanisms or significantly degrade the material properties of the aluminum alloy. Accordingly, the aluminum alloy might comprise zinc only as an impurity or in form of a contamination, e.g. due to a contamination of other ingredients of the aluminum alloy.

In particular, the aluminum alloy is essentially free of zinc. This means that zinc, especially zinc impurities, can be present in the aluminum alloy in an amount that does not exceed about 0.10% by weight zinc based on the total weight of the provided aluminum alloy.

Advantageously, the aluminum alloy according to the invention can have an improved processability during additive manufacturing (abbreviated to AM) processes compared to known alloys, since some of the magnesium in the aluminum alloy is replaced with manganese. Advantageously, by providing a certain part of the solid solution strengthener in the form of manganese instead of magnesium the proportion of magnesium in the aluminum alloy can be reduced. The added manganese can serve as a solid solution strengthener replacing the subtracted magnesium. Advantageously, Manganese has a lower vapour pressure than magnesium and is therefore less likely to vaporize during additive manufacturing. Further advantageously, manganese turned out to be a suitable substitute for magnesium because, in the composition according to the invention, it should have no adverse effects on the quality of the finished component, wherein e.g. detrimental intermetallic phases can be avoided and the solidification cracking susceptibility is not affected significantly. Further advantageously, manganese may have a higher solid solution strengthening effect in aluminum than magnesium, especially in the aluminum alloy according to the invention. It was found that, given its beneficial combination of solid solubility in aluminum, ability to be super-saturated in aluminum during rapid solidification, and slow diffusivity in aluminum, along with its high solid solution strengthening effect per addition, manganese is an optimal replacement for magnesium in aluminum alloys, especially in HTPSA, to provide a build-up material that can be processed as well as possible in additive manufacturing processes and enables high component quality, wherein the components have high strength and high ductility.

Advantageously, the addition of zirconium in the given range results in the formation of Al₃(Zr) precipitates in the aluminum alloy that provide additional strengthening and have a good thermal stability. The Al₃(Zr) precipitates in the aluminum alloy can act as nucleation sites for refined, equiaxed aluminum grains, which contribute to a reduction in hot cracking susceptibility, wherein hot cracking refers to the formation of shrinkage cracks during the solidification of the aluminum alloy in additive manufacturing processes. The addition of zirconium, especially the formation of Zr-based strengthening precipitates in the aluminum alloy, has the advantage, that zirconium is relatively cheap, especially compared to alloying elements like scandium.

Advantageously, the combination of manganese and zirconium as well as the other alloying elements according to the invention provides an aluminum alloy with improved AM processability (compared to known alloys) and good component quality while maintaining high strength and high ductility, especially after heat treatment. It can be assumed that the aluminum alloy also has thermal elevated temperature performance (after heat treatment). As the aluminum alloy is also particularly light, it is suitable for additive manufacturing of components for aerospace, defense, automotive or structural components and the like. Advantageously, the aluminum alloy could also be used for heat exchanger applications or for semiconductor applications.

Another advantage of the aluminum alloy according to the invention is that the risk of fire associated with vaporized and condensated magnesium particles can be reduced in filter systems of additive manufacturing machines. Fine magnesium particles combined with fine zinc particles have known to have caused temperature rise in atomization plant filters creating a risk of fire in filters of additive manufacturing machines. By not intentionally adding zinc and by substituting some of the magnesium by manganese the risks associated with the vaporization and reactivity of these elements can be reduced, wherein the operational safety of additive manufacturing machines can be increased.

The production method of producing an aluminum alloy according to the invention comprises at least the following steps. In one step at most 4.50% by weight magnesium, about 0.10% by weight to about 5.00% by weight manganese, about 1.00% by weight to about 2.00% by weight zirconium (each based on the total weight of the aluminum alloy to be produced) and aluminum as the remainder are provided, especially as powder in each case. The materials can be provided separately from each other.

In one step the provided amounts of magnesium, manganese, zirconium and aluminum are brought together, e.g. alloyed with each other.

In one step the aluminum alloy is produced, preferably by means of a rapid solidification process, wherein the aluminum alloy is produced such that the finished aluminum alloy does not comprise any intentionally added zinc. The rapid solidification process can be selected from a group consisting of atomization, spray deposition, melt spinning, melt extraction and beam glazing. In principle, another technique can be used to produce the aluminum alloy.

Preferably, the production method can be performed to provide a powder made of the aluminum alloy, especially to provide a powder available from the aluminum alloy.

In an optional step, the finished or provided aluminum alloy can be packaged.

Provision is understood in the context of the invention to mean both on-site production as well as delivery of the ingredients of the aluminum alloy.

Insofar as the aluminum alloy is packaged, a packing process preferably takes place by exclusion of atmospheric moisture. Advantageously, the aluminum alloy can subsequently be stored under reduced moisture to avoid, for example, caking effects, thereby improving the storage stability of the aluminum alloy. An advantageous packaging material also prevents moisture, in particular atmospheric moisture, from entering the aluminum alloy.

An aluminum alloy produced by a method according to the invention can advantageously be used as a powder material in a method for the layer-by-layer production of a three-dimensional object, in which successive layers of the object to be formed from this material are successively solidified at corresponding or predetermined locations by the input of energy, preferably of electromagnetic radiation, in particular by the input of laser light. The aluminum alloy can preferably be used for laser powder bed fusion (LPBF), e.g. direct metal laser sintering (DMLS), electron beam melting (EBM), selective heat sintering (SHS), selective laser melting (SLM) or selective laser sintering (SLS) or another additive manufacturing process like powder-directed energy deposition.

The method according to the invention for producing at least one component, preferably by means of laser powder bed fusion, comprises at least the steps described below. The method preferably comprises an additive manufacturing process for the production of one or more additively manufactured three-dimensional objects. The additive manufacturing process preferably includes laser powder bed fusion, e.g. direct metal laser sintering (DMLS), electron beam melting (EBM), selective heat sintering (SHS), selective laser melting (SLM), selective laser sintering (SLS), wherein the invention is not limited to this, but other additive manufacturing processes can be used, e.g. powder-directed energy deposition.

In one step of the method, an aluminum alloy according to the invention in powder form is applied to a building field of an additive manufacturing machine, in particular an aluminum alloy which is obtained by a production method according to the invention. Preferably, a certain amount of the aluminum alloy is applied in the form of a thin layer to the building field. However, the invention is not restricted to layer wise application of the aluminum alloy powder. The aluminum alloy powder provides the build-up material for the object to be produced.

In another step of the method, the applied aluminum alloy selectively melted and resolidified at locations corresponding to a cross-section of the component to be produced. The selective melting can preferably be performed by irradiation with radiation energy. In particular, the selective irradiation can be performed by means of a controllable laser irradiation unit of the AM machine. However, the invention is not restricted to laser radiation, wherein particle radiation is also possible, e.g. electron radiation. The term “melting” in this case is understood to mean at least partial melting, especially of the aluminum alloy powder, and fusing with subsequently solidified material. However, the powder grains or particles of the aluminum alloy can preferably be completely melted by the local introduction of energy by irradiation and can then solidify again.

In the method according to the invention, the steps of application of the aluminum alloy powder, melting and solidification are repeated until the component, in particular at least one three-dimensional object, is completed. In particular, the aluminum alloy can be applied to the building field in layers, wherein a respective layer of the aluminum alloy is selectively melted at those points which are intended to form parts of the object to be manufactured, before a new layer of the aluminum alloy is applied onto the previous layer and is then selectively melted. This sequence can be repeated until the entire object to be manufactured is finished.

By way of example, an AM machine performing the method can comprise a platform that provides together with further elements of the AM machine the building or construction field. The platform can be located on a carrier within the AM machine at a certain distance from an irradiation unit mounted above it, which is suitable for solidifying or melting the applied aluminum alloy. The aluminum alloy can be positioned on the platform so that an uppermost layer of the aluminum alloy coincides with the level that is to be melted and resolidified. The carrier can be adjusted during the manufacturing process, in particular laser sintering or laser melting, so that each newly applied layer of the aluminum alloy is at the same distance from the irradiation unit and can be melted in this way by the action of the irradiation unit.

A component according to the invention, in particular a three-dimensional object, comprises an aluminum alloy according to the invention. In principle, the component can only consist of the aluminum alloy. The component is preferably obtainable by a method according to the invention. In particular, the component is obtainable by laser powder bed fusion (LPBF), e.g. direct metal laser sintering (DMLS), electron beam melting (EBM), selective heat sintering (SHS), selective laser melting (SLM) or selective laser sintering (SLS) or another additive manufacturing process, wherein the aluminum alloy according to the invention is used as the build-up material.

Finally, the aluminum alloy according to the invention is used to produce a component, in particular a three-dimensional object, in an additive manufacturing process. Preferably, the aluminum alloy is used for laser powder bed fusion (LPBF), e.g. direct metal laser sintering (DMLS), electron beam melting (EBM), selective heat sintering (SHS), selective laser melting (SLM) or selective laser sintering (SLS) or another additive manufacturing technique.

The method for producing an aluminum alloy, the method for producing a component using the aluminum alloy as well as the use of the aluminum alloy in an additive manufacturing process and the component comprising the aluminum alloy according to the invention share the advantages of the inventive aluminum alloy as described previously.

### DETAILED DESCRIPTION OF THE EMBODIMENTS

Further particularly advantageous embodiments and developments of the invention will become clear from the dependent claims and the following description, wherein the independent claims of each claim category can also be developed analogously to the dependent claims and exemplary embodiments of another claim category, and in particular individual features of various exemplary embodiments or variants can also be combined to form new exemplary embodiments or variants.

The aluminum alloy, hereinafter referred to as the alloy, preferably does not comprise any intentionally added scandium (Sc). Accordingly, the alloy might comprise scandium only as an impurity or in form of a contamination, e.g. due to impurities of other ingredients of the aluminum alloy.

Preferably, the aluminum alloy is essentially free of scandium. This means that scandium, especially scandium impurities, in the aluminum alloy can be present in an amount that does not exceed about 0.10% by weight scandium based on the total weight of the provided aluminum alloy.

Preferred, scandium is present in less than about 0.05% by weight scandium, preferably less than about 0.04% by weight scandium, further preferably less than about 0.03% by weight scandium, each based on the total weight of the alloy. The amount of scandium in the alloy can be less than about 0.02% by weight scandium, less than about 0.01% by weight scandium, less than about 0.005% by weight scandium or less than about 0.001% by weight scandium, each based on the total weight of the provided aluminum alloy.

Alternatively or in addition, preferably in addition, zinc is present in less than about 0.05% by weight zinc, preferably less than about 0.04% by weight zinc, further preferably less than about 0.03% by weight zinc, each based on the total weight of the provided aluminum alloy. The amount of zinc in the alloy can be less than about 0.02% by weight zinc, less than about 0.01% by weight zinc, less than about 0.005% by weight zinc or less than about 0.001% by weight zinc, each based on the total weight of the provided aluminum alloy.

By excluding zinc from the alloy as far as possible, or by keeping the amount of zinc in the alloy as low as possible, the operation of the AM machine can be made even safer by reducing the risk of fires. By deliberately omitting scandium, using only Zr instead to form strengthening precipitates in the alloy, the alloy is cheaper to produce.

Particularly preferred, the aluminum alloy consists only of aluminum, magnesium, manganese and zirconium with the respective quantities stated above. This means that no further substances are intentionally added to the alloy. However, the alloy can comprise (unavoidable) impurities, e.g. due to contamination of one of the ingredients. Preferably, the amount of a respective impurity is less than about 0.10% by weight, preferably less than about 0.05% by weight, further preferably less than about 0.02% by weight, each based on the total weight of the alloy.

Advantageously, by using only four basic elements, an alloy with improved AM processability can be provided in a comparatively simple manner. In that only zirconium is used to form strengthening precipitates in the alloy, for example instead of scandium, the aluminum alloy is relatively cheap to produce.

In a preferred embodiment, the aluminum alloy can comprise about 3.00% by weight to about 4.40% by weight magnesium, especially about 3.18% by weight to about 4.34% by weight magnesium. The alloy can comprise about 0.25% by weight to about 0.50% by weight manganese. The alloy can comprise about 1.20% by weight to about 1.50% by weight zirconium (based on the total weight of the alloy in each case). The alloy can comprise aluminum as the remainder or as balance in order to produce the finished alloy. An alloy containing the aforementioned substances in the specified amount or ranges is referred to as AD1 in the description. Particularly preferred, the aluminum alloy (AD1) can consist of aluminum, magnesium, manganese and zirconium with the respective quantities stated above.

Advantageously, the alloy consisting of the above-mentioned materials in the above-mentioned quantity ranges is characterized by a particularly optimized AM processability. As a result, the disadvantages of known alloys mentioned at the beginning can be reduced particularly significantly during additive manufacturing processes.

The aluminum alloy (AD1) can be realized such that the amount of magnesium is less than about 4.25% by weight magnesium, preferably less than about 4.00% by weight magnesium, further preferably less than about 3.75% by weight magnesium, further preferably less than about 3.50% by weight magnesium, further preferably less than about 3.25% by weight magnesium, each based on the total weight of the alloy.

The aluminum alloy (AD1) can be realized such that the amount of manganese is more than about 0.30% by weight manganese, preferably more than about 0.35% by weight manganese, further preferably more than about 0.40% by weight manganese, further preferably more than about 0.45% by weight manganese, each based on the total weight of the alloy.

The invention further relates to an aluminum alloy, wherein the aluminum alloy comprises at most 4.50% by weight magnesium and more than about 1.00% by weight manganese and about 1.00% by weight to about 2.00% by weight zirconium and aluminum as the remainder. The aforementioned aluminum alloy can be realized such that the alloy does not comprise any intentionally added scandium. Preferably, the aluminum alloy is essentially free of scandium. Alternatively or in addition, the aforementioned aluminum alloy can be realized such that the alloy does not comprise any intentionally added zinc. Preferably, the aluminum alloy is essentially free of zinc. Furthermore, the aforementioned aluminum alloy can consist only of aluminum, magnesium, manganese and zirconium. In this case, the previously given specifications regarding the maximum contents of zinc and/or scandium and/or impurities apply accordingly.

It is noted that the aluminum alloy described immediately before represents an independent partial aspect of the invention. The aforementioned aluminum alloy is in particular suitable for additive manufacturing processes (as build-up material). The aluminum alloy is preferably suitable for heat treatment, especially after processing a powdered aluminum alloy in an additive manufacturing process. Preferably, a high-temperature precipitation strengthened aluminum alloy can be obtained by means of heat-treating of the aluminum alloy as described immediately before.

Advantageously, by using a relatively large proportion of manganese of more than about 1.00% by weight in the aluminum alloy in combination with other alloying elements, with correspondingly less magnesium being used, the AM processability of the aluminum alloy can be improved particularly effectively (compared to known alloys). As mentioned already, the added manganese can serve as a solid solution strengthener replacing the subtracted magnesium. Advantageously, Manganese has a lower vapour pressure than magnesium and is therefore less likely to vaporize during additive manufacturing. Further advantageously, manganese turned out to be a suitable substitute for magnesium because, in the composition described above, it should have no adverse effects on the quality of the finished component, wherein e.g. detrimental intermetallic phases can be avoided and the solidification cracking susceptibility is not affected significantly. As mentioned already, manganese advantageously may have a higher solid solution strengthening effect in aluminum than magnesium, especially in the aluminum alloy according to the invention. Advantageously, by replacing a certain proportion of magnesium with manganese, especially by increasing the proportion of added manganese to more than about 1.00% by weight, a particularly strong strengthening effect can be achieved. It was found that given its beneficial combination of solid solubility in aluminum, ability to be super-saturated in solution during rapid solidification, and slow diffusivity in aluminum, along with its high solid solution strengthening effect per addition, manganese is an optimal replacement for magnesium in aluminum alloys, especially in HTPSA, to provide a build-up material that can be processed as well as possible in additive manufacturing processes and enables high component quality, wherein the components have high strength and high ductility. It can be assumed that the aluminum alloy also has thermal elevated temperature performance (after heat treatment).

Advantageously, the addition of zirconium in the given range results in the formation of Al₃(Zr) precipitates in the aluminum alloy that provide additional strengthening and have a good thermal stability. The Al₃(Zr) precipitates in the aluminum alloy can act as nucleation sites for refined, equiaxed aluminum grains, which contribute to a reduction in hot cracking susceptibility, wherein hot cracking refers to the formation of shrinkage cracks during the solidification of the aluminum alloy in additive manufacturing processes. The addition of zirconium, especially the formation of Zr-based strengthening precipitates in the aluminum alloy, has the advantage, that zirconium is relatively cheap, especially compared to alloying elements like scandium.

Advantageously the combination of manganese and zirconium as well as the other alloying elements in the composition described above provides an aluminum alloy with particularly improved AM processability (compared to known alloys) and high component quality while providing a particularly high strength and high ductility, especially after heat treatment. It can be assumed that the aluminum alloy also has thermal elevated temperature performance after heat treatment. As the aluminum alloy is also particularly light, it is suitable for additive manufacturing of components for aerospace, defense, automotive or structural components and the like. Advantageously, the aluminum alloy could also be used for heat exchanger applications or for semiconductor applications.

By replacing part of the magnesium with manganese, the fire hazard in filter systems of AM machines can be reduced.

It is noted once again that the aluminum alloy described immediately before represents an independent partial aspect of the invention. That is, the composition of the previously described aluminum alloy according to a second embodiment can differ in some aspects from a first aluminum alloy embodiment. However, it is optionally possible for the aluminum alloy to be realized according to the first aluminum alloy embodiment. In this optional case, the aluminum alloy of the second embodiment does not comprise any intentionally added zinc, wherein the aluminum alloy contains more than about 1.00% by weight manganese to about 5.00% by weight manganese (instead of about 0.10% by weight to about 5.00% by weight manganese as in the first embodiment). It is possible that such an aluminum alloy does not comprise any intentionally added scandium. It is possible that such an aluminum alloy consists only of aluminum, magnesium, manganese and zirconium. In this case, the previously given specifications regarding the maximum contents of zinc and/or scandium and/or impurities apply accordingly.

A method for producing an aluminum alloy can also be performed in such a way that in one step at most 4.50% by weight magnesium, more than about 1.00% by weight manganese, about 1.00% by weight to about 2.00% by weight zirconium (each based on the total weight of the aluminum alloy to be produced) and aluminum as the remainder are provided, especially as powder in each case. Optionally, more than about 1.00% by weight manganese to about 5.00% by weight manganese can be provided. The materials can be provided separately from each other.

In one step the provided amounts of magnesium, manganese, zirconium and aluminum are brought together, e.g. alloyed with each other.

In one step the aluminum alloy is produced, preferably by means of a rapid solidification process. Optionally, the aluminum alloy is produced such that the finished aluminum alloy does not comprise any intentionally added zinc. The rapid solidification process can be selected from a group consisting of atomization, spray deposition, melt spinning, melt extraction and beam glazing. In principle, another technique can be used to produce the aluminum alloy. Preferably, the production method can be performed to provide a powder made of the aluminum alloy, especially to provide a powder available from the aluminum alloy. In an optional step, the finished or provided aluminum alloy can be packaged.

An aluminum alloy produced by the aforementioned method and/or an aforementioned aluminum alloy (according to the second embodiment) can be used to produce a component, in particular a three-dimensional object, in an additive manufacturing process. Preferably, the aforementioned aluminum alloy (according to the second embodiment) and/or the aluminum alloy produced by the aforementioned method can be used in the method according to the invention for producing at least one component, preferably by means of laser powder bed fusion. A preferred component, in particular a three-dimensional object, can comprise the aforementioned aluminum alloy (according to the second embodiment), especially can consist thereof.

The aforementioned aluminum alloy can in particular comprise about 1.30% by weight to about 2.60% by weight magnesium, especially about 1.36% by weight to about 2.58% by weight magnesium. The alloy can comprise about 3.00% by weight to about 3.50% by weight manganese. The alloy can comprise about 1.20% by weight to about 1.50% by weight zirconium (based on the total weight of the alloy in each case). The alloy can comprise aluminum as the remainder or as balance in order to produce the finished alloy. An alloy containing the aforementioned substances in the specified amount or ranges is referred to as AD2 in the description. In general, such an alloy could comprise one or more additional, especially intentionally added, substances, e.g. different alloying elements. However, it is preferred that the aluminum alloy (AD2) consists of aluminum, magnesium, manganese and zirconium with the respective quantities stated above.

Advantageously, a relatively large proportion of manganese in the alloy, especially in relation to the magnesium used, means that the lowest possible proportion of magnesium can be used, so that the disadvantageous properties of magnesium during AM can be further reduced. Accordingly, the aforementioned alloy is easy to process during additive manufacturing and allows the best possible component quality. Furthermore, a higher amount of manganese, e.g. more than 3% by weight, will increase the strengthening effect of the alloy. The above alloy enables a particularly ideal AM processability along with particularly high strength and, which is to be assumed, elevated temperature performance (especially after heat treatment) and is relatively cheap.

The amount of magnesium (in AD2) can be less than about 2.50% by weight, preferably less than about 2.25% by weight magnesium, further preferably less than about 2.00% by weight magnesium, further preferably less than about 1.75% by weight magnesium, further preferably less than about 1.50% by weight magnesium, each based on the total weight of the alloy.

The amount of manganese (in AD2) can be more than about 3.10% by weight manganese, preferably more than about 3.20% by weight manganese, further preferably more than about 3.30% by weight manganese, further preferably more than about 3.40% by weight manganese, each based on the total weight of the alloy.

The aluminum alloy can be realized such that the amount of zirconium is more than about 1.30% by weight based on the total weight of the alloy. Alternatively or in addition the aluminum alloy can be realized such that the amount of zirconium is less than about 1.50% by weight based on the total weight of the alloy. The proportion of zirconium can especially refer to an alloy according to AD1 or AD2.

The aluminum alloy, especially according to AD1 or AD2, can be fabricated into a feedstock suitable for use in an additive manufacturing process. In particular, the feedstock is suitable for use in an additive manufacturing process that utilizes a powder or a wire as feedstock. It is preferable that the aluminum alloy is fabricated into a powder, especially to provide the feedstock for an AM process. Alternatively, the aluminum alloy can be fabricated into a rod, a wire, a ribbon, chips or a foil.

The aluminum alloy, especially the aluminum alloy powder of the feedstock, can be a spherical aluminum alloy powder or a non-spherical aluminum alloy powder or a mixture thereof. These properties of the powder can preferably refer to an alloy according to AD1 or AD2.

A powder size distribution of the aluminum alloy powder, especially the aluminum alloy powder of the feedstock, can be about 15 μm to about 110 μm (particle diameter). Preferably the alloy powder has a particle size distribution of d10=32 μm, d50=42 μm and d90=57 μm. The average diameter of the particles d50 indicates that 50% of the powder particles or powder grains are below the particle diameter mentioned. Particle sizes can be measured per ISO 13322-2. These properties of the powder can preferably refer to an alloy according to AD1 or AD2.

As mentioned previously, the aluminum alloy can be heat treated to generate a high-temperature precipitation strengthened aluminum alloy (HSPTA). The heat treatment or heat aging of the alloy can be an optional step in the method for producing the component. In principle, heat treatment of the alloy can also be carried out independently of the production of the component. The heat treatment can preferably be performed on an AD1 type alloy or an AD2 type alloy.

Preferably, the heat treatment can be performed at a later time after completion of the component, i.e. heat treatment is not carried out on the feedstock. Preferably, the heat treatment is performed provided the component is completely manufactured. In particular, the heat treatment can be performed after the additive manufacturing process being completed. This means that the precipitation hardening can be performed on the additively manufactured component that is made of the alloy. Preferably, the component comprising the alloy has a thermally stable microstructure that remains unchanged by exposure to elevated temperatures for extended times (elevated temperature performance), especially after heat treatment of the component.

The heat-treating of the completed component comprising the alloy, especially to achieve precipitation and dispersion hardening, can be performed at a temperature of about 350° C. to about 450° C. The heat-treating can be performed for a period of about 1 hour to about 6 hours and especially air quenched. Preferably heat-treating is performed under an inert gas atmosphere. Advantageous, thermally stable Al₃(Zr) precipitates that act as precipitation strengtheners can be formed in the alloy due to heat treatment.

A preferred component, especially an additively manufactured object, is obtainable by heat treatment of the component comprising the aluminum alloy. The heat treatment of the component can be performed as described above, especially after the component is printed completely. The heat treatment of the alloy as part of the component provides a component that comprises, preferably consists of, a high-temperature precipitation strengthened aluminum alloy (HSPTA).

For the sake of completeness, it is pointed out that heat treatment could also be performed on the alloy per se, i.e. independently of an AM process or an additively manufactured component. This means that the alloy itself can be heat treated as described above for precipitation hardening of the alloy.

Preferably, the alloy is realized such that the component comprising the alloy, in particular consisting thereof, has (at room temperature) an average yield strength greater than 300 MPa (megapascal), preferably greater than 325 MPa, further preferably greater than 350 MPa, further preferably greater than 375 MPa, further preferably greater than 400 MPa, in particular greater than 408 MPa, the component being heat treated. The mechanical properties can be obtained with an AD1 type alloy.

Alternatively or in addition, the alloy can be realized such that the component comprising the alloy, in particular consisting thereof, has (at room temperature) an average tensile strength greater than 325 MPa, preferably greater than 350 MPa, further preferably greater than 375 MPa, further preferably greater than 400 MPa, further preferably greater than 425 MPa, in particular greater than 435 MPa, the component being heat treated. The mechanical properties can be obtained with an AD1 type alloy.

Alternatively or in addition, the alloy can be realized such that the component comprising the alloy, in particular consisting thereof, has (at room temperature) an average elongation of break of more than 10%, preferably more than 12.5%, further preferably more than 15%, in particular more than 17%, the component being heat treated. The mechanical properties can be obtained with an AD1 type alloy.

The component with the abovementioned mechanical properties is preferably obtainable by means of laser powder bed fusion, e.g. direct metal laser sintering (DMLS), electron beam melting (EBM), selective heat sintering (SHS), selective laser melting (SLM) or selective laser sintering (SLS) or another additive manufacturing technique, e.g. powder-directed energy deposition, using an AD1 type alloy as build-up material and subsequent heat treatment of the component. The yield strength, tensile strength and elongation at break can be determined with the aid of the so-called tensile test according to DIN EN ISO 6892-1 or according to ASTM E8/E8M and is known to the person skilled in the art.

Preferably, the alloy is thermally stable up to an operating temperature of at least 250° C. (thermal elevated temperature performance), especially after heat treatment. Further preferably, the alloy, especially a component consisting of the alloy, has certain mechanical properties after heat treatment as described hereinafter. For example, at 100° C. the tensile yield of the alloy is ˜341 MPa and the UTS (ultimate tensile strength) is ˜381 MPa.

The alloy can be realized such that a specific strength (quotient from tensile strength and density) of the alloy at room temperature, especially when fabricated into a component, is from about 117 kN·m/kg (as-built) to about 162 kN·m/kg (heat treated). The mechanical properties can be obtained with an AD1 type alloy.

The alloy can comprise at least one of silicon (Si), copper (Cu), nickel (Ni), titanium (Ti) or tin (Sn) impurities. Preferably, a silicon impurity can be present in the alloy in an amount that does not exceed 0.20% by weight, further preferably 0.15% by weight. The silicon and/or copper and/or nickel and/or titanium and/or tin impurities can in each case be present in the alloy in an amount that does not exceed about 0.10% by weight, preferably about 0.05% by weight. The amount of a respective impurity in the alloy can be less than about 0.04% by weight, preferably less than about 0.03% by weight, further preferably less than about 0.02% by weight, further preferably less than about 0.01% by weight, further preferably less than about 0.005% by weight, in particular less than about 0.001% by weight, each based on the total weight of the alloy.

The alloy can be realized such that, especially when fabricated into a component, the alloy is anodizable. This advantageous property of the alloy is possible because the alloy is essentially free of silicon.

In an exemplary embodiment, an aluminum alloy according to the invention can comprise 3.0% to 4.0% by weight magnesium, 0.1% to 0.5% by weight manganese, 1.0% to 1.5% by weight zirconium (in each case based on the final weight of the aluminum alloy to be produced) and aluminum as the remainder. The alloy does not comprise any intentionally added zinc and is an AD1 type alloy.

The aluminum alloy as described above was used as build-up material for additive manufacturing of specimens for testing mechanical properties mentioned in Table 1 and Table 2. Additive manufacturing was performed by laser powder bed fusion using the EOS M290 laser powder bed fusion machine (EOS GmbH, Electro Optical Systems, Germany). If heat treatment was performed after the manufacturing process, the parameters were as follows: 400° ° C. for 6 hours in inert gas with inert gas air quench. The yield strength, tensile strength and elongation at break were determined with the aid of the so-called tensile test according to DIN EN ISO 6892-1.

TABLE 1
Mechanical properties of additively manufactured
AD1 specimens after heat treatment.

| | Yield | Tensile | Elongation | |
|---|---|---|---|---|
| | Strength | Strength | at break | Number of |
| | (MPa) | (MPa) | (%) | samples |
| Vertical | 408.9 | 435.4 | 17.88% | 42 |
| Standard | 3.3 | 1.2 | 1.99% | 42 |
| Deviation (SD) | | | | |
| Horizontal | 418.7 | 438.6 | 18.79% | 30 |
| Standard | 2.8 | 2.3 | 0.65% | 30 |
| Deviation (SD) | | | | |
| Combined | 413.0 | 436.7 | 18.3% | 72 |
| Standard | 5.7 | 2.4 | 1.6% | 72 |
| Deviation (SD) | | | | |

TABLE 2
Mechanical properties of additively manufactured
AD1 specimen without heat treatment (as-built).

| | Yield | Tensile | Elongation | |
|---|---|---|---|---|
| | Strength | Strength | at break | Number of |
| | (MPa) | (MPa) | (%) | samples |
| Vertical | 238.9 | 318.9 | 26.24% | 21 |
| Standard | 4.4 | 2.3 | 1.46% | 21 |
| Deviation (SD) | | | | |
| Horizontal | 275.4 | 323.4 | 26.93% | 15 |
| Standard | 1.9 | 3.3 | 0.90% | 15 |
| Deviation (SD) | | | | |
| Combined | 254.1 | 320.8 | 26.53% | 36 |
| Standard | 18.6 | 3.5 | 1.29% | 36 |
| Deviation (SD) | | | | |

Finally, it is pointed out once again that the aluminum alloy and the methods described in detail above are merely exemplary embodiments, which can be modified in the most varied of ways by the person skilled in the art without departing from the scope of the invention. For example, the amount of manganese in the alloy can in principle be about 0.15% by weight or 0.20% by weight, each based on the total weight or amount of the alloy. Furthermore, the use of the indefinite article “a” or “an” does not exclude the possibility that the relevant features can also be present more than once.

1. An aluminum alloy comprising:
at most 4.50% by weight magnesium,
about 0.10 to about 5.00% by weight manganese,
about 1.00 to about 2.00% by weight zirconium, and
aluminum as the remainder,
wherein the aluminum alloy does not comprise any intentionally added zinc.

2. The aluminum alloy according to claim 1, wherein the aluminum alloy does not comprise any intentionally added scandium.

3. The aluminum alloy according to claim 1, wherein the aluminum alloy consists of aluminum, magnesium, manganese and zirconium.

4. The aluminum alloy according to claim 1, comprising:
about 3.00 to about 4.40% by weight magnesium,
about 0.25 to about 0.50% by weight manganese,
about 1.20 to about 1.50% by weight zirconium, and
aluminum as the remainder.

5. The aluminum alloy according to claim 1, wherein the amount of magnesium is less than about 4.25% by weight magnesium.

6. The aluminum alloy according to claim 1, wherein the amount of manganese is more than about 0.30% by weight manganese.

7. An aluminum alloy according to claim 1, comprising:
at most 4.50% by weight magnesium,
more than about 1.00% by weight manganese,
about 1.00 to about 2.00% by weight zirconium, and
aluminum as the remainder.

8. The aluminum alloy according to claim 7 comprising:
about 1.30 to about 2.60% by weight magnesium,
about 3.00 to about 3.50% by weight manganese,
about 1.20 to about 1.50% by weight zirconium, and
aluminum as the remainder.

9. The aluminum alloy according to claim 7, wherein the amount of magnesium is less than about 2.50% by weight magnesium.

10. The aluminum alloy according to claim 7, wherein the amount of manganese is more than about 3.10% by weight manganese.

11. The aluminum alloy according to claim 1 fabricated into a powder, a rod, a wire, a ribbon, chips or foil and/or wherein the aluminum alloy is a spherical aluminum alloy powder or a non-spherical aluminum alloy powder or a mixture thereof.

12. The aluminum alloy according to claim 1, wherein zinc is present in less than about 0.05% by weight zinc and/or wherein scandium is present in less than about 0.05% by weight scandium.

13. The aluminum alloy according to claim 1 fabricated into a component having a yield strength after heat treatment greater than 300 MPa and/or having a tensile strength after heat treatment greater than 325 MPa and/or having an elongation of break after heat treatment of more than 10%.

14. A method of producing an aluminum alloy according to claim 1, comprising the steps:
(i) providing as powder, at most 4.50% by weight magnesium, about 0.10 to about 5.00% by weight manganese, about 1.00 to about 2.00% by weight zirconium and aluminum as the remainder;
(ii) bringing together the provided magnesium, manganese, zirconium and aluminum; and
(iii) producing the aluminum alloy by a rapid solidification process, wherein the aluminum alloy does not comprise any intentionally added zinc.

15. A method for producing a component comprising the steps:
(i) applying in a layer, an aluminum alloy according to claim 1 in powder form to a building field;
(ii) selectively solidifying the applied aluminum alloy at locations corresponding to a cross-section of the component to be produced; and
(iii) repeating the steps of application and solidification until the component is completed.

16. The method according to claim 15 further comprising heat-treating the component at a temperature of about 350° ° C. to about 450° ° C. for a time of about 1 hour to about 6 hours.

17. A component comprising an aluminum alloy according to claim 1, wherein the component is obtained through additive manufacturing.

18. A component according to claim 17, wherein the component is obtainable by heat treatment of the component comprising the aluminum alloy.

19. A method of manufacturing a component in an additive manufacturing process, comprising:
applying an aluminum alloy according to claim 1; and
solidifying the aluminum alloy via laser powder bed fusion.
